(19) United States
(12) Patent Application Publication
(10) Pub. No.: US 2013/0268395 A1
(43) Pub. Date: Oct. 10, 2013

(54) AUTOMATED PRODUCT SELECTION AND DISTRIBUTION SYSTEM

(71) Applicant: ADAM I. SANDOW, Boca Raton, FL (US)

(72) Inventor: ADAM I. SANDOW, Boca Raton, FL (US)

(21) Appl. No.: 13/443,689

(22) Filed: Apr. 10, 2012

(51) Int. Cl. G06Q 30/02

(52) U.S. Cl. 705/26.7

(57) ABSTRACT

An automated method and system for selection and distribution of products include maintaining a database containing product information for a plurality of products; receiving user profile data for at least one user; selecting at least one recommended product from the plurality of products; and generating a personalized report regarding the at least one recommended product directed to the at least one user. The method and system also include improving the selection accuracy by updating user profile data and/or product information based on a completed product survey by the at least one user.

### FIELD OF THE DISCLOSURE

The present disclosure relates to a system and method for automated, targeted selection and distribution of products to consumers.

### BACKGROUND

Various methods are known to be useful for product marketing and, in particular marketing of personal care products. Traditionally, product manufacturers have displayed advertisements that describe their products so as to pique interest and to encourage consumers to purchase a product; have distributed samples of products to consumers at random or based on a consumer's previous buying habits; and have distributed samples of products to consumers who specifically requested a sample of the products. The effectiveness of these techniques can be limited. A number of samples typically are provided to consumers who are not likely to want or use them. A consumer may not take the time to review product information and actively identify samples to receive. Furthermore, the relatively small amount included in a sample size may not allow a consumer to effectively evaluate the product and develop an affinity or preference for it. While conventional methods in the prior art are useful in some instances, they also have deficiencies and the potential remains open for more efficient and effective methods and systems to promote products through selection and distribution of the products, and particularly in the area of personal care products.

### SUMMARY OF THE INVENTION

A method for selection and distribution of products, such as, beauty and wellness products, vitamins, supplements and fragrances, is described herein. The method can include maintaining a database containing product information describing attributes of a plurality of products that are available for selection and distribution; and receiving user profile data for at least one user, wherein the user profile data contains descriptions of attributes of users. The attributes of the products and the attributes of the users can include attributes that correlate positively, negatively and/or neutrally with one another. The method can also include selecting at least one recommended product from the plurality of products, by searching the database for products having product information correlating relatively more positively with the attributes of the users as provided in the user's profile data; and generating a personalized report regarding the at least one recommended product directed to the at least one user.

The plurality of products can include personal care products. The product information can include information including ingredients, targeted skin tone, potential allergies, fragrance preferences, targeted problem, type, viscosity, target age range, retail price, and combinations thereof. The user profile data can include data including skin type, allergies, beauty concerns, desirable fragrances, undesirable fragrances, desirable brands, undesirable brands, age, beauty spending, and combinations thereof.

The step of receiving user profile data can also include receiving user attributes from at least one of receiving direct input from a user regarding the user's attributes; inferring attributes based on the direct input from the user; identifying attributes based on the user's product survey results; and inferring attributes based on another user with a similar user profile. The method can also include receiving the user profile data and storing the user profile data in the database.

The step of selecting a recommended product can also include searching the database for products having product information correlating relatively less negatively, or relatively more positively, with the attributes of the users as provided in the user's profile data. Selecting a recommended product can also include comparing the user profile data to the product information; identifying a set of one or more correlating attributes; determining for each of the correlating attributes whether the correlation is positive, negative, or neutral; and selecting a product with the greatest number of positive correlating attributes as the recommended product. Selecting the recommended product can also include selecting the product with the greatest positive correlation attribute value. Selecting the recommended product can also include ranking the plurality of products or a subset of the plurality of products and selecting the highest ranked product.

The method can also include excluding products having negative correlations from selection as a recommended product. The method can also include excluding previously recommended products from selection as a recommended product and the user profile data can include previously recommended products.

The method can also include repeating the steps of selecting a recommended product and generating a personalized report at regular intervals. The personalized report can relate to a correlation between the product information of the at least one recommended product and the user's profile data.

The method can also include: maintaining a product inventory for at least a portion of the plurality of products, wherein the product inventory includes the recommended product; distributing the recommended product to the user; and providing the user with a product survey related to the user's experience with the recommended product. The product inventory can include full-size products.

The method can also include receiving a completed product survey from a user related to the user's experience with the recommended product; and updating the user's profile data according to the information in the completed product survey. The method can also include receiving a completed product survey; and updating the product information for the recommended product according to the information in the completed product survey. The method can also include receiving a completed product survey for the recommended product and providing at least some of the information in the completed product survey to an associated vendor.

The method for selection and distribution of products as described herein can also include the steps of: maintaining a database containing user profile data for at least one user and product information for a plurality of products; maintaining a product inventory for at least some of the plurality of products; selecting at least one recommended product from the plurality of products by searching the database for products having product information correlating to at least some of the user's profile data; and generating a personalized report regarding the recommended product and directed to the at least one user; and providing the personalized report to the user with at least one of the recommended product and purchase information for the recommended product. The step of selecting the recommended product can also include determining a likelihood that a product will suit a user.

A system for selection and distribution of materials is also described herein. The system can include at least one data processor having access to a data memory configured to maintain a database and being programmed to execute instructions. The database can contain information describing a plurality of products and an inventory for at least some of the plurality of products. The database can also contain user profile data for at least one user.

The data processor can be programmed to execute a process for selecting at least one recommended product from the plurality of products based on a search for products having at least some product information correlating relatively more positively to the user's profile data. The data processor can also be programmed to execute a process for generating a personalized report regarding the recommended product for the at least one user. The data processor can also be programmed to initiate a process for distributing the recommended product to a recipient.

The system can also include a product inventory for at least some of the plurality of products, wherein the distributing process distributes the recommended product from the product inventory. The data processor can also be programmed to execute a process for updating the database to reflect distribution of the recommended product from the product inventory.

The data processor can also be programmed to initiate a process for providing a product survey to the user and to execute a process for updating at least one of the user's profile data and the product information based on a completed product survey.

These and other features, objects and advantages of the present method and system will become more apparent to one skilled in the art from the following description and claims when read in light of the accompanying drawings.

### BRIEF DESCRIPTION OF THE DRAWINGS

FIG. 1 is a high-level flow diagram of an example of the method described herein.

FIG. 2 is a flow diagram of another example of the method described herein.

FIG. 3 is a flow diagram of another example of the method described herein.

FIG. 4 is a stylized overview of an example of the system described herein connected to a plurality of interconnected computing devices.

FIG. 5 is a high level block diagram of an example of the system described herein.

FIG. 6 is a high level block diagram of another example of the system described herein.

### DETAILED DESCRIPTION

A method and system for the targeted selection and distribution of products to consumers is described. The method can include a consumer enrolling in a subscription program and filling out a survey regarding the consumer's experiences and needs related to personal care products (e.g., beauty care products, wellness, vitamins, supplements, fragrances, etc.). The survey questions contain a level of detail and prompting for the consumer to state characteristics and preferences that are relevant to the suitability of the consumer to one or more products that are offered. The detailed survey can be analyzed to determine the consumer's most pressing needs with respect to the personal care products at issue (e.g., wrinkles, facial blemishes, hair care, etc.). The detailed survey can also be analyzed to determine a recommended personal care product that has the potential to address the pressing need of the individual and sending a package that includes the recommended personal care product and a personalized report about the recommended product and how it can be used to address that particular consumer's pressing need. The method can also include the consumer filling out a follow-up results survey response or comment regarding the consumer's impressions and experience with recommended personal care product(s) or those for which the supplier provides samples.

Finding an ideal personal care product can be a difficult process for any individual. In addition, people are creatures of habit and many continue to purchase the same products as adults that their parents purchased when they were children. This results for many reasons, such as fear of the unknown. These factors combined with the fact that the selection of personal care products can involve numerous choices among various product attributes, and the fact that the same product can have different effects on different persons, makes modifying purchasing habits difficult. Finally, the search will often require continual analysis of objective product information that may not apply to them and/or repeated trial and error of costly personal care products.

A method and system for a subjective selection of products, and particularly personal care products, is described herein. Although described with respect to personal care products, it is to be understood that the methods and system described herein can also be used for other types of products. As used herein, the term “personal care products” refers without limitation to products related to beautification. wellness or personal hygiene, having ranges of characteristic that may be more or less sought by consumers. For example, personal care products can include cosmetics, skin care products, hair care products, soaps and bodywashes, perfumes and other body sprays, wellness products, vitamins, nutritional supplements, etc.

The method and system provide an automated capability to continually update product and user information based on consumer feedback, such as product surveys. This results in continuous improvement of the information analyzed to identify recommended products particularly suitable for a specific user and the user base as a whole. As used herein, the term “recommended product” refers to a personal care product determined to have a reasonable likelihood that the product will suit a user based on the user's purposes, needs, wants and tastes as identified in their user profile. Recommended products are generally personalized determinations and can vary for each user.

One object of the method and system is to perform an individualized selection of a personal care product for a user. Another object is to provide a useful quantity of a personal care product to allow the user to conduct a meaningful evaluation of the product. Another object of the method and system is to refine future selections in view of product survey information received from that user and from others.

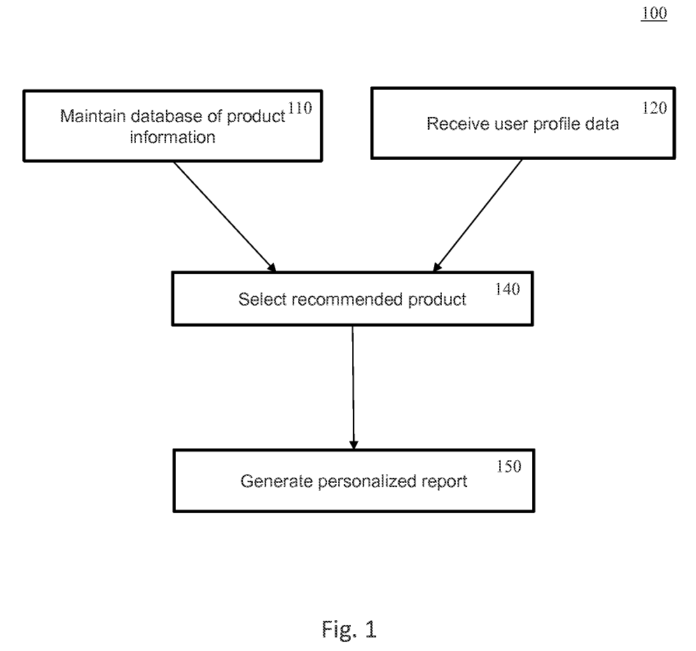

In disclosed embodiments and as shown in FIG. 1, the method 100 can include the steps of maintaining a database containing product information describing a plurality of products 110; receiving user profile data for at least one user 120; and selecting at least one recommended product from the plurality of products 140 based on the product information and the user profile data. The database, as well as the receiving and selecting processes, can be computerized.

Product information can include various information relating to a product. Product information can describe attributes of a product including, without limitation, product name (e.g. descriptive title, or other identifier), product ingredients, targeted skin tone, potential allergies, fragrance, targeted problem or area of improvement, morphological type (e.g. serum, lotion, solid, powder, etc.), viscosity or texture, target age range, retail price, brand, origin of ingredients (e.g., organic, non-GMO, etc.), and other information regarding the product. Product information can be received from manufacturers, distributors, and sellers of the product; from users of the product (e.g., reviews and ratings); and/or from other sources.

The database can also include detailed ingredient information regarding a plurality of ingredients. The plurality of ingredients can include various ingredients used in personal care product manufacturing. The ingredient information can describe attributes of an ingredient including, without limitation, ingredient name, properties, benefits, and issues such as allergies. The detailed ingredient information can be associated with a product, e.g. products listing an ingredient in the product information, and/or can be associated with a user profile, e.g. if the user profile data lists an ingredient or a concern, allergy, etc. related to an ingredient.

The method 100 can also include maintaining a product inventory for at least a portion of the plurality of products. The database can also contain information regarding the product inventory including, without limitation, a product identifier and quantity in inventory for each product. The products in inventory can include deluxe or full-sized products. The products in inventory can also be provided in amounts intended to last for an evaluation period that is sufficient to develop a customer preference, such as at least two weeks, at least a month, or at least two months when used according to the manufacturer's instructions.

One problem with conventional samples for personal care products is that they are provided in amounts that are insufficient to determine whether or not they are as effective and suited for the consumer as hoped. Users otherwise would need to conduct a program of product testing and research and to obtain and try products from multiple sources (e.g., stores, websites, etc.). In contrast, the method and system described herein provide personal care products that should work for the user's particular personal care needs and provide the personal care products in amounts that enable the user to assess whether the product is actually working or not without the user needing to waste time researching the product or purchasing it.

A user can provide profile data relating to his or her personal care attributes including, without limitation, skin type, allergies, beauty concerns, desirable fragrances, undesirable fragrances, desirable brands, undesirable brands, age, beauty spending, ingredient source (e.g., organic, non-GMO, etc.), other personal preference information, and previously recommended or reviewed products. User profile data can also include user information such as user name, address, e-mail and other contact information. User profile data can also be stored in the database. Each user profile can also be associated with a substantially unique identifier. The attributes of the products and the attributes of the users can be directly input by a user or vendor, respectively. Attributes can also be inferred from the direct input, such as survey answers or user profile data. The inferences can be based on identified associations, for example certain age ranges can infer that wrinkles or pimples would be a likely beauty concern, etc.

The attributes of the products and the attributes of the users can include attributes that correlate with one another. As used herein, the terms “correlate” and “correlating” with respect to attributes refer to product information attributes that are relevant to user attributes identified in a user's profile data. The detailed ingredient information can also be cross referenced to identify correlations between attributes of products and attributes of users. For example, a user profile listing an allergy to X can correlate to product information listing a potential allergy as X, an ingredient as X, or an ingredient Y that is known to be derived from X. In another example, a user profile listing a skin type of Z can correlate to product information indicating that the product is beneficial for Z skin. Such correlations can be used to increase or decrease the likelihood that a particular product should be recommended to a particular user.

The attributes of the products and the attributes of the users can also correlate positively or negatively with one another. A pair of product and user attributes can correlate positively if the relation weighs in favor of recommending the product. A pair of product and user attributes can correlate negatively if the relation weighs against recommending the product. For example, a correlation for allergy can be negative if the product information indicates that the product may contain ingredients that the user attributes indicate the user is allergic to. A correlation for beauty concern can be positive if the product information indicates that the product may be directed to a beauty concern identified by the user in his or her profile data. Attributes can also correlate neutrally with one another.

The step of selecting a recommended product 140 can include determining a likelihood that a product will benefit a user. The determination can be based on a search for products having product information correlating to the user's profile data and, in particular, product attributes correlating positively or negatively with the user's attributes.

The selection can include searching the database for products having product information correlating relatively more positively with the user attributes provided in the user's profile data than other products in the database. The selection can also include searching the database for products having product information correlating relatively less negatively with the user attributes provided in the user's profile data.

The selection can also include excluding certain products from consideration for selection as the recommended product. For example, products having certain negative correlations can be excluded. For example, a product can be excluded if the product information indicates a negative correlation for allergy based on the user's profile data.

Products that were previously recommended to a particular user can also be excluded from the selection. For example, products previously recommended to a user can be included in the user's profile data and all previously recommended products can be excluded. Alternately, products that were previously recommended within a predetermined period (e.g. 6 months, 1 year, etc.) can be excluded, or previously recommended products that have also been distributed to the user can be excluded. Products that are not included in the current product inventory can also be excluded from the selection as a recommended product.

The step of selecting at least one recommended product 140 can include sorting products based on individual or tiered criteria. For example, a primary subset from the plurality of products can be identified based on a primary attribute or a set of primary attributes; and a secondary subset can also be identified from the primary subset based on a secondary attribute or a set of secondary attributes, etc. The number of tiers can include one, two, three, four, five, or more.

Some attributes concern objective comparisons between the characteristics of the consumer and those of the offered products. Other attributes may be subjective to the consumer. Information supplied by the consumer as to what may be suitable is matched to information about the product, known to the supplier. In some situations, information that is subjective to the supplier may come into play, for example in a situation where the supplier may be interested in promoting an under-used product or a newly introduced product.

Attributes are matched both positively and negatively. For example, a primary consumer attribute can include a negative correlation for a particular chemical constituent due to allergy. A secondary attribute can include a positive correlation for a user-specific beauty concern. In such an example, the user profile might include data that the user is allergic to red #40 dye and has a specific beauty concern for hair (e.g., managing color treated hair). Thus, the primary subset would identify and include the products with product information indicating that they do not contain red #40 dye. From among the primary subset products, the secondary subset would identify and include the products with product information indicating that they are hair care products. A tertiary subset could include hair care products designed to manage color treated hair. The tiered criteria and ordering will generally be selected by default (e.g., the entity that developed or manages the database), but can sometimes be selected by a user.

Selecting the recommended product 140 can also include ranking products. As used herein, the term “ranking” refers to ordering the products in terms of highest likelihood of suitability to lowest likelihood of suitability (i.e. highest ranked product has the highest likelihood of suitability). Ranking can include consideration of any number of attributes and can employ a variety of algorithms. For example, ranking can include determining and comparing the number of positive correlations. Ranking can also include determining and comparing the number of negative correlations. Ranking can also include assigning different weights to certain attributes (e.g. beauty concern can be weighted greater than desired fragrance). Weights can be assigned according to a default assignment (e.g., the entity that developed or manages the database), or can be provided by a user as part of the user's profile data. The highest ranked product can be selected as the recommended product.

The determination of suitability can also be based on information external to the user's profile data. For example, the method 100 can also include associating a user with another user's profile data that has similar profile data. For example, the profile data for User A and User B may indicate that they have the same or similar skin types, the same or similar beauty concerns, and the same or similar allergies. The step of selecting the recommended product 140 can also include referencing data, such as desirable brands or undesirable brands, from the similar profile. However, a user's own profile data would take precedence in the event of any conflict between profile preferences.

The method 100 can also include generating a personalized report regarding the recommended product directed to the user 150. The steps of selecting a recommended product 140, generating a personalized report 150 can be automated and repeated at regular intervals. For example, a recommendation and report can be issued weekly, bi-monthly, monthly, quarterly, or less frequently. A user can also select the frequency of the recommendations and reports, and this preference can be included in the user's profile data.

The personalized report can include at least some information on the recommended product and at least one reason the recommended product was selected that references the user profile data. In particular, the personalized report can relate to the correlation between the product information of the recommended product and the user's profile data. For example, the reason can identify at least one user attribute and the correlation to an attribute of the recommended product. For example, the reason can include the product addressing a beauty concern listed in the profile, or the product not containing an ingredient that the profile lists as an allergy.

The personalized report can also include a user's name and the name of the recommended product. An example of a personalized report can include:
Dear Mary,
We selected ______ brand of moisturizer ($80 retail value) because you told us you have dry skin, you're allergic to grapes and love the smell of roses. Please note that ______ product's active ingredient is rosewater and does NOT contain Liposeen which is a derivative of grapes.
Please try it and tell us what you think.

The personalized report can be provided to a user as an electronic communication, as a written communication, or both.

The method 100 can also include distributing the recommended product to the user 161, or providing information regarding how to purchase the recommended product 162, or both. The recommended product or purchase information can be provided together with the personalized report.

In one arrangement, multiple tiers of memberships can be offered to users. For example, users can elect to participate in an informational program in which the user receives the personalized reports and related information or a product subscription program in which the user also received an actual recommended product. The product subscription program can include a fee or various fee levels. For example, a user may wish to receive one recommended product per distribution or more than one recommended product per distribution. A user's program selection can be contained in the database, including in the user profile data or in other locations. It is also possible to provide for favorable fee treatment in exchange for user participation in the return of product surveys or other feedback evaluating or commenting on products tried.

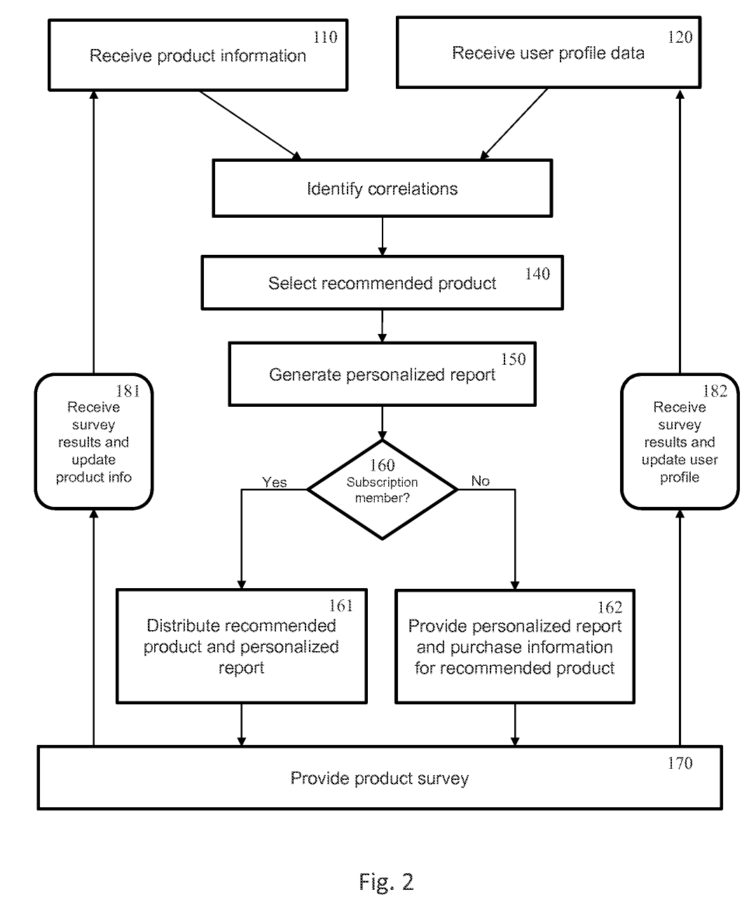

As shown in FIG. 2, the method 100 can also include determining whether a user is a member of the informational program or the product subscription program 160. If the user is in the informational program, the personalized report and information regarding how to purchase the recommended product can be provided to the user 162. Information regarding how to purchase products can include links to websites selling the products.

If the user is in the product subscription program, the personalized report and the recommended product can be distributed to the user 161 according to distribution information provided by the user. Distribution information can include a recipient name, a shipping address, and other delivery instructions. The method 100 can also include updating the database to reflect execution of the distribution and passing out from the inventory of the product provided to the user.

The method 100 can also include providing the user with a product survey related to the user's experience with the recommended product 170. Upon receipt of a completed product survey from a user, the method can also include updating the user's profile data according to the information in the completed product survey 182. Any portion of the completed survey can be used to update the user profile data.

The product information for the recommended product can also be updated according to the information in the completed product survey 181. The method 100 can also include aggregating a plurality of survey results, including results from multiple users, for a particular product. Aggregating can also include multiple results from one user or can include only one completed survey from each user for a particular product. For example, the first completed survey from a particular user can be included while subsequent results for the same product from the same user can be excluded. Alternately, the most recently completed survey from a user can replace prior results for the same product from the same user.

Aggregating can also include storing survey results information from each completed product survey and associating the information with particular user profile data. For example, survey information may include that a user with skin type X had a beneficial experience with product Y in treating beauty concern Z.

Aggregating can also include calculating aggregate user experience quotients for each product. The user experience quotient can include a sum of feedback provided about the product where the feedback is positive, less a sum of feedback provided about the product where the feedback is negative, divided by a total number of completed surveys providing the feedback. This same approach can be applied to one or more elements of product information for a product (e.g., function, fragrance, comfortable to apply, etc.). Multiple user experience quotients can also be calculated for each product based on various user profile data types. For example, user experience for a product can be aggregated for all survey results from users with skin type X, with a second calculation for users with skin type Y.

At least some of the information in a completed product survey can also be provided to the associated vendor. Associated vendors can include entities that manufacture and/or sell the product, entities that supply the product to the product inventory, or other third parties involved in the development, promotion, sale or distribution of the product. One or more associated vendors can be associated with each of the plurality of products. The associated vendor(s) can also be included in the product information for each product.

The method can also allow users to provide reviews or feedback by filling out surveys for products that were not sent out as part of the method. If a completed product survey includes information regarding the user's experiences with a product other than the recommended product, the method 100 can also include identifying the reviewed product and updating the user profile, product information, and associated vendor accordingly.

The method and system can also be utilized for product development and marketing research. For example, a database operator can utilize the database of users to identify users who may be particularly helpful for a company launching a new consumer product. A company launching a new skin care product for treating wrinkles can contact the database operator who can (i) identify users with user profile information of particular interest for the new product (e.g., they have the particular beauty concern addressed by the new product), (ii) provide those users with information regarding the new product, and (iii) obtain feedback from those consumers regarding their experience with the new product. This method provides the company with a nationwide focus group instead of the conventional approach of recruiting locally, and enables the company to receive feedback from target consumers instead of professional testers. The new products could be provided to the user's free of charge and could be in addition to the samples received as part of the paid subscription program.

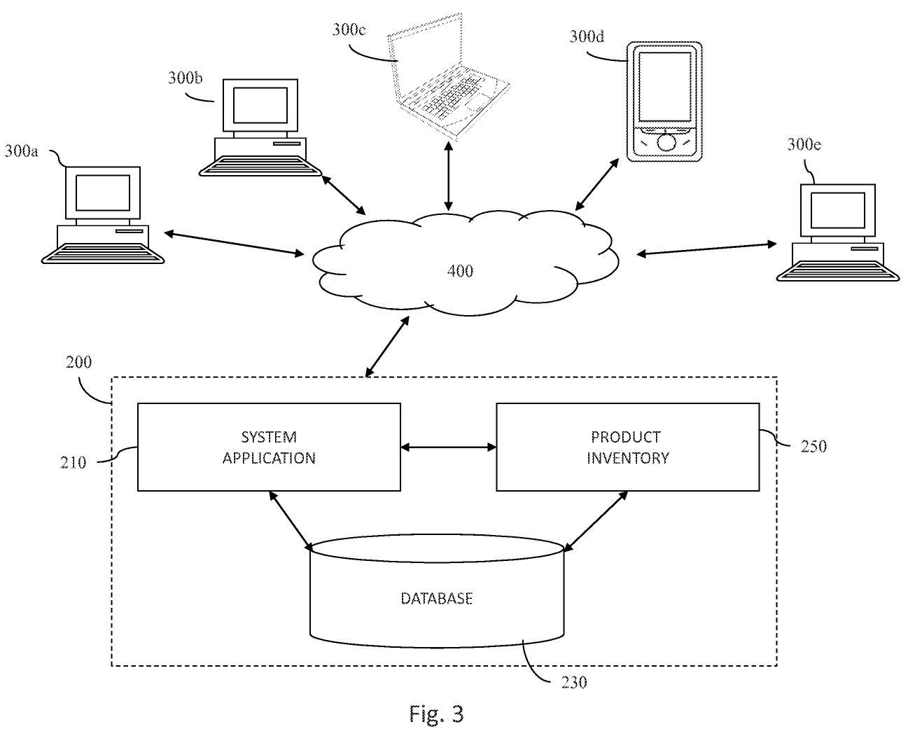

A system 200 for automated selection and distribution of products is also described herein. The system 200 and its operation can embody at least a portion of the methods described above. The methods can also be implemented using a software application 210 executed by a processor 215. Processors 215 can include any central processing unit (CPU), microprocessor, micro-controller, or computational device or circuit for executing instructions and be connected to a communication infrastructure (e.g., a communications bus, cross-over bar, or network). As shown in FIG. 3, the system 200 can be connected to at least one terminal device 300. A user can input data to a terminal device 300 for transmission to the at least one data processor 215 of the system 200 through the communication infrastructure 400.

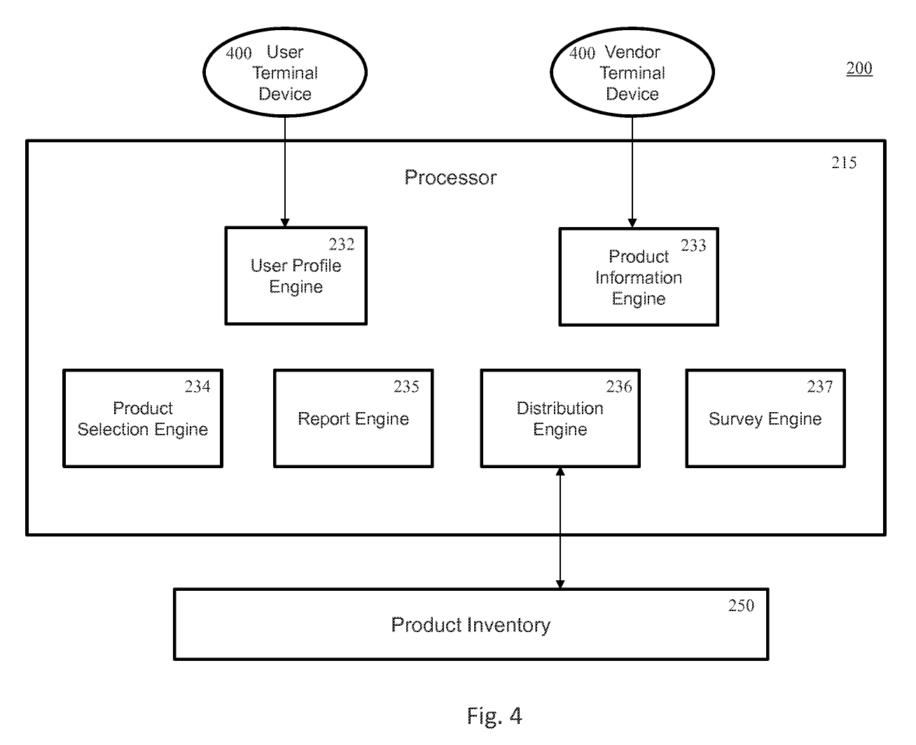

As shown in FIGS. 3 and 4, the system 200 can include at least one data processor 215 having access to a data memory configured to maintain a database 230 and being programmed to execute instructions. The database 230 can contain product information and user profile data.

The system 200 can include a user interface for users to input user profile data. The system 200 can also include a vendor interface for vendors or other third parties to input product information. The system 200 can employ a graphical user interface (GUI) to facilitate use, including input of data by a user or input of product information by a vendor. The GUI can be viewed and used on a screen on one of the terminal devices including, without limitation, desktop and portable computers such as notebooks and tablets (e.g., IPAD®), and on handheld devices such as smart phones (e.g., IPHONE®). The GUI can include various screens, graphics and text to facilitate the various functions.

As shown in FIG. 4, the system 200 can also include at least one processor devoted to use as a user profile database engine 232. The system 200 can also include at least one processor devoted to use as a product information database engine 233.

The system 200 can also include at least one processor devoted to use as a product selection engine 234. The data processor can be programmed to execute a process for selecting at least one recommended product from the plurality of products.

The system 200 can also include at least one processor devoted to use as a report engine 235. The data processor can be programmed to execute a process for generating a personalized report regarding the recommended product for the at least one user.

The system 200 can also include a product inventory 250 and at least one processor devoted to use as a distribution engine 236. The data processor can be further programmed to initiate a process for distributing the recommended product from the product inventory to a user or other designated recipient.

The system 200 can also include at least one processor devoted to use as a survey engine 237. The data processor can be programmed to initiate a process for providing a product survey to a user. The data processor can be further programmed to execute a process for updating the user profile database, the product information database, or both based on a received completed product survey.

The various engines of the system 200 can include the same processor or on multiple processors.

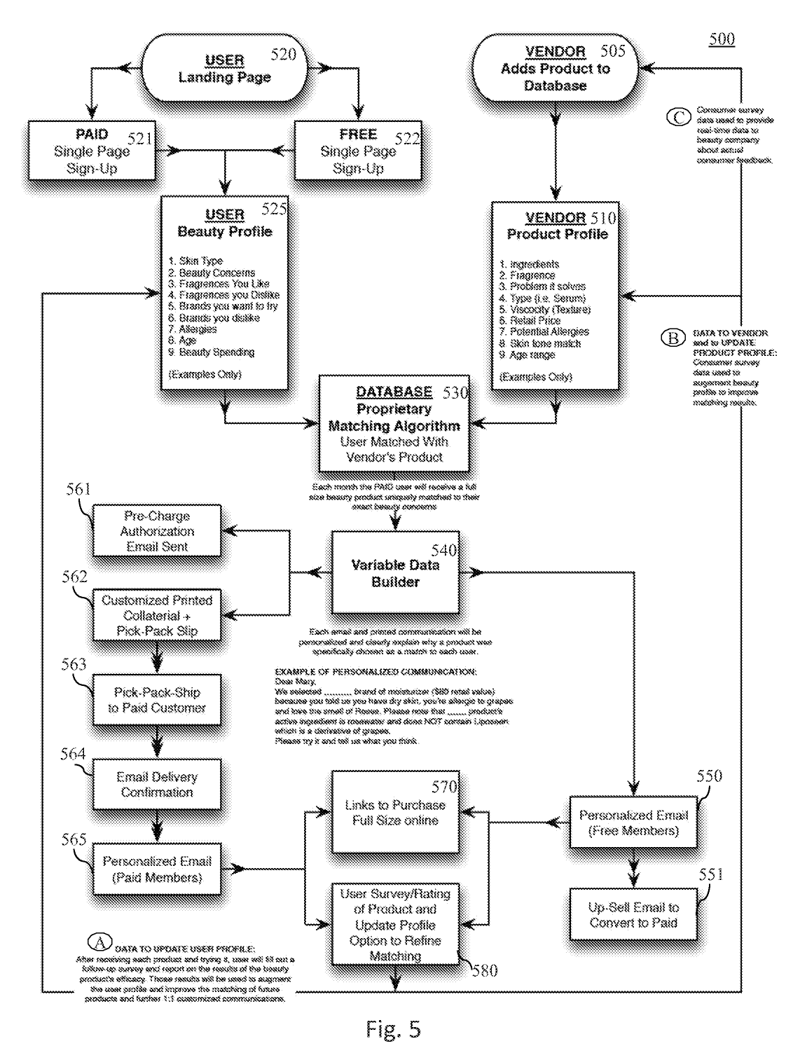

In one arrangement as shown in FIG. 5, the system 500 and method can include a product profile 510 comprising the product information. The product information can be added to the database by an associated vendor 505. The system 500 can also include a user landing page 520, wherein a user can select to participate in the product subscription program (e.g. paid program) via a sign up page 521 or the informational program (e.g. free program) via a sign up page 522. Upon selection of a program, the user can enter his or her profile data 525. The product profile and user profile information can be stored in a database 530. Using the product profile and user profile information, the system can select a recommended product from the product profile based on the user's profile data.

The system 500 can also include a variable data builder 540 to generate a personalized report for a user regarding the recommended product. For informational (free) program members, the system can send the personalized report to the user 550. The communication can also include links to purchase the product 570, a product survey 580 (for example, if the user purchases and uses the recommended product), and an offer to convert membership from the informational/free program to the product subscription (paid) program 551. Although referenced as “free” and “paid” programs, the informational and subscription programs can both require enrollment fees of differing amounts.

For product subscription (paid) program members, the system can initiate a process for distribution of the recommended product, including sending a pre-charge authorization notice to the user 561, retrieving the recommended product from the product inventory, printing the personalized report and packing it with the recommended product 562, 563, and providing confirmation of package shipping and/or delivery 564. The system can also send an electronic communication to the paid member 565 including an electronic copy of the personalized report, links to purchase the product 570 (for example, if the user wishes to obtain more of the recommended product), and/or a product survey 580 related to the user's experience with the recommended product.

The system can receive completed product surveys from users and use the results to update the user's profile data (A), update the product profile for the recommended product (B), and/or provide real-time information to the associated vendor about actual consumer feedback (C).

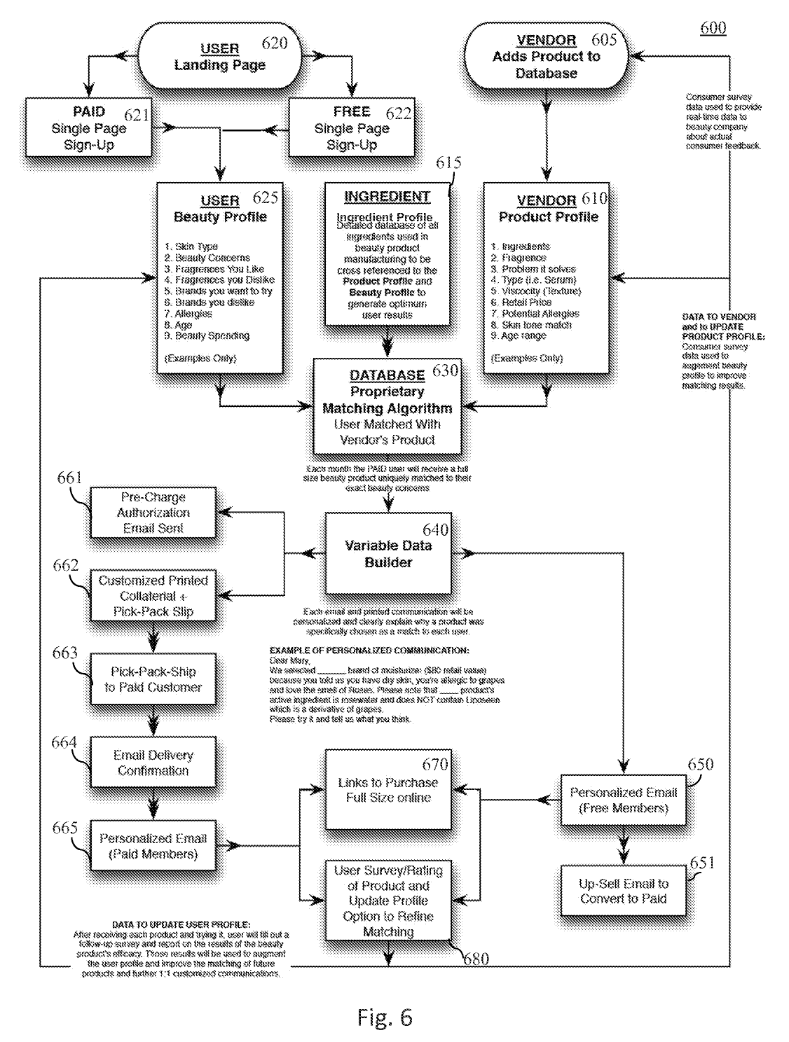

In another arrangement as shown in FIG. 6, the system 600 and method can include a product profile 610 comprising the product information provided by an associated vendor 605. The system 600 can also include an ingredient profile 615 with detailed ingredient information on a wide range of ingredients used in beauty product manufacturing. The system can also include a user landing page 620, wherein a user can select a program via paid and free sign up pages, 621, 622 respectively. The user can also enter his or her profile data 625. The product profile 610, ingredient profile 615, and user profile 625 information can be stored in a database 630. The database 630 can comprise a single database, or any of the product, ingredient and user information can be included in separate databases.

Using the product profile 610, ingredient profile 615 and user profile information 625, the system can select a recommended product from the product profile based on the user's profile data and other ingredient information. By cross-referencing the ingredient profiles to the ingredient profiles and user profiles, the system can generate optimum results for an individualized selection of a recommended product for a particular user.

The system 600 can also include a variable data builder 640 to generate a personalized report for a user regarding the recommended product. The system can send the personalized report to the user 650 via a personalized e-mail 650, 665. The communication can also include links to purchase the product 670 and a product survey 680.

For informational (free) program members, the communication can also include an offer to convert membership from the informational/free program to the product subscription (paid) program 651. For product subscription (paid) program members, the system can initiate a process for distribution of the recommended product to the user 661-665.

The present disclosure can be embodied in the form of methods and apparatus for practicing those methods. The system can also be embodied in the form of program code embodied in tangible media, such as floppy diskettes, CD-ROMs, DVD-ROMs, blu-ray disks, hard drives, or any other machine-readable storage medium, wherein, when the program code is loaded into and executed by a machine, such as a computer, the machine becomes an apparatus for practicing the invention. The system can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The foregoing is provided for purposes of illustrating, explaining, an describing embodiments of the method and system. Modifications and adaptations to these embodiments will be apparent to those skilled in the art and may be made without departing from the scope or spirit of this disclosure.

1. A method for selection and distribution of products, comprising the steps of:
maintaining a database containing product information describing attributes of a plurality of products that are available for selection and distribution;
receiving user profile data for at least one user, wherein the user profile data contains descriptions of attributes of users;
wherein the attributes of the products and the attributes of the users can include attributes that correlate positively, negatively and/or neutrally with one another;
selecting at least one recommended product from the plurality of products, by searching the database for products having product information correlating relatively more positively with the attributes of the users as provided in the user's profile data; and
generating a personalized report regarding the at least one recommended product directed to the at least one user.

2. The method according to claim 1, wherein the plurality of products comprise personal care products;
the product information comprises information selected from the group consisting of ingredients, targeted skin tone, potential allergies, fragrance, targeted problem, type, viscosity, target age range, retail price, and combinations thereof; and
the user profile data comprises data selected from the group consisting of skin type, allergies, beauty concerns, desirable fragrances, undesirable fragrances, desirable brands, undesirable brands, age, beauty spending, and combinations thereof.

3. The method according to claim 1, wherein the step of receiving user profile data further comprises:
receiving user attributes from at least one of:
receiving direct input from a user regarding the user's attributes;
inferring attributes based on the direct input from the user;
identifying attributes based on the user's product survey results; and
inferring attributes based on another user with a similar user profile; and
storing the user profile data in the database.

4. The method according to claim 1, wherein the step of selecting a recommended product further comprises searching the database for products having product information correlating relatively less negatively with the attributes of the users as provided in the user's profile data.

5. The method according to claim 1, wherein the step of selecting a recommended product further comprises:
comparing the user profile data to the product information;
identifying a set of one or more correlating attributes;
for each of the correlating attributes, determining whether the correlation is positive, negative, or neutral; and
selecting a product with the greatest number of positive correlating attributes as the recommended product.

6. The method according to claim 5, further comprising excluding products having negative correlations from selection as a recommended product.

7. The method according to claim 1, wherein the step of selecting the recommended product comprises ranking the plurality of products or a subset of the plurality of products and selecting the highest ranked product.

8. The method according to claim 1, wherein the user profile data further includes previously recommended products, and previously recommended products are excluded from selection as a recommended product.

9. The method according to claim 1, wherein the personalized report relates to a correlation between the product information of the at least one recommended product and the user's profile data.

10. The method according to claim 1, wherein the steps of selecting a recommended product and generating a personalized report are repeated at regular intervals.

11. The method according to claim 1, further comprising:
maintaining a product inventory for at least a portion of the plurality of products, wherein the product inventory includes the recommended product;
distributing the recommended product to the user; and
providing the user with a product survey related to the user's experience with the recommended product.

12. The method according to claim 11, wherein the product inventory comprises full-size products.

13. The method according to claim 11, further comprising:
receiving a completed product survey from a user related to the user's experience with the recommended product; and
updating the user's profile data according to the information in the completed product survey.

14. The method according to claim 11, further comprising:
receiving a completed product survey; and
updating the product information for the recommended product according to the information in the completed product survey.

15. The method according to claim 11, further comprising receiving a completed product survey for the recommended product and providing at least some of the information in the completed product survey to an associated vendor.

16. A method for selection and distribution of products, comprising the steps of:
maintaining a database containing user profile data for at least one user and product information for a plurality of products;
maintaining a product inventory for at least some of the of a plurality of products;
selecting at least one recommended product from the plurality of products, by searching the database for products having product information correlating to at least some of the user's profile data; and
generating a personalized report regarding the recommended product and directed to the at least one user; and
providing the personalized report to the user with at least one of the recommended product and purchase information for the recommended product.

17. The method according to claim 16, wherein the step of selecting the recommended product comprises determining a likelihood that a product will suit a user.

18. A system for selection and distribution of materials, comprising:
at least one data processor having access to a data memory configured to maintain a database and being programmed to execute instructions;
wherein the database contains information describing a plurality of products and an inventory for at least some of the plurality of products;
wherein the database further contains user profile data for at least one user;
wherein the data processor is programmed to execute a process for selecting at least one recommended product from the plurality of products based on a search for products having at least some product information correlating relatively more positively to the user's profile data;
wherein the data processor is further programmed to execute a process for generating a personalized report regarding the recommended product for the at least one user; and
wherein the data processor is further programmed to initiate a process for distributing the recommended product to a recipient.

19. The system according to claim 18, further comprising a product inventory for at least some of the plurality of products, wherein the distributing process distributes the recommended product from the product inventory, and
the data processor is further programmed to execute a process for updating the database to reflect distribution of the recommended product from the product inventory.

20. The system according to claim 18, wherein the data processor is further programmed to initiate a process for providing a product survey to the user; and
the data processor is further programmed to execute a process for updating at least one of the user's profile data and the product information based on a completed product survey.
